(19) United States
(12) Patent Application Publication
(10) Pub. No.: US 2011/0000778 A1
(43) Pub. Date: Jan. 6, 2011

(54) EVAPORATIVE DESALINATION APPARATUS OF SEA WATER, USING PHASE CHANGE MEDIUM

(76) Inventors: Hee Youl Kwak, Daejeon-City (KR); Sang Kook Yun, Busan-City (KR)

Correspondence Address: JENKINS, WILSON, TAYLOR & HUNT, P. A., 3100 Tower Blvd., Suite 1200, DURHAM, NC, 27707, US

(21) Appl. No.: 12/603,821

(22) Filed: Oct. 22, 2009

(30) Foreign Application Priority Data
Jul. 6, 2009 (KR) 10-2009-0061196

(51) Int. Cl. C02F 1/04

(52) U.S. Cl. 202/185.1; 202/235

(57) ABSTRACT

There is provided an evaporative desalination apparatus of sea water using a phase change medium, and more particularly, a desalination method by evaporation, for producing fresh water from sea water by using various high heat sources, such as solar heat, engine heat and the like. Instead of a conventional method in which warm water is supplied to an evaporator of an desalination apparatus to evaporate seawater, the present invention provides the phase change medium capable of supplying a much more amount of heat to the evaporator, thereby enhancing the efficiency of the desalination apparatus to produce a great quantity of fresh water or manufacturing a compact desalination apparatus.

The method of providing the amount of heat according to the present invention is to circulate the phase change medium. In the present invention, the latent heat generated when a gas of high heat is injected and is phase-changed to a liquid state is used to evaporate sea water. That is, whereas the conventional method uses sensible heat by only a temperature difference of water which is the medium to supply the amount of heat to the evaporator, the present invention uses the latent heat which is the phase change energy.

If the same amount of heat is provided to the evaporator, the present invention significantly reduces a flow amount of the medium, compared with the conventional method. Therefore, the desalination apparatus according to the present invention is very effective because power required for operating a pump is reduced, a compact desalination apparatus in dimension is realized, a greater quantity of fresh water is produced, compared with that produced by the conventional desalination apparatus in the same size.

### CROSS-REFERENCE TO RELATED PATENT APPLICATION

This application claims the benefit of Korean Patent Application No. 10-2009-0061196, filed on Jul. 6, 2009, in the Korean Intellectual Property Office, the disclosure of which is incorporated herein in its entirety by reference.

### BACKGROUND OF THE INVENTION

1. Field of the Invention

The present invention relates to an evaporative desalination apparatus of sea water to produce fresh water by evaporating sea water, using high temperature water by solar heat or ship engine heat, in which, instead of a conventional medium of supplying hot water to an evaporator inside the desalination apparatus, a phase change medium is supplied to evaporate sea water, thereby producing a greater quantity of fresh water by using latent heat provided by the phase change medium during a phase change from a gas to a liquid.

2. Description of the Related Art

In general, systems for a process of separating fresh water from sea water are largely classified into a thermal energy system, a mechanical/electrical energy system and a recycling energy system, based on the energy sources. Methods used for the process include evaporation/distillation, reverse osmosis, freezing, electrodialysis, among the others. Among these methods, the desalination method using solar heat uses thermal energy. In this case, the systems are divided into a single effect system which uses one evaporator and a multi-effect system which uses a number of evaporators to increase a yield of fresh water. The multi-effect system is largely classified into multi-stage flash distillation (MSF) and multi-effect evaporation (MED). This method is applied to a large system which uses a high temperature steam or which produces a great quantity of fresh water.

On the other hand, in a conventional desalination system where solar heat is used as a heat source, as illustrated in FIG. 1, hot water of 60° C.˜80° C., the temperature absorbed from solar heat, is supplied to an evaporator to produce fresh water from sea water. The system comprises: an evaporator 101 for evaporating sea water, a condenser 102 for liquefying evaporated steam, an ejector 103 for creating a vacuum in a space between the condenser 102 and the evaporator 101, a solar collector 104, and a thermal storage tank 105 for storing solar heat.

The principles of the system are as follows: low temperature water of about 45° C. is heated while it circulates through the inside of the thermal storage tank 105 storing the heat source, such as solar heat or the like, to generate warm water of about 60° C. The warm water flows into an evaporation pipe 106 in the evaporator 101 and heats sea water outside the evaporation pipe 106 to be evaporated. The evaporated steam is liquefied on the external surface of the condenser 102. Sea water flows into a condensation pipe 107 of the condenser 102. The sea water condenses the steam outside the condensation pipe 107 and flows into the evaporator 101 as its temperature rises. The sea water flowing into the evaporator 101 is heated by the warm water inside the evaporation pipe 106, emitting steam. The remaining sea water is discharged by the ejector 103. The warm water inside the evaporation pipe 106 circulates to the thermal storage tank as its temperature again falls.

This system using solar heat is of the important technology to secure alternative water resources since it uses low energy, it is environment-friendly, it is less-scaled and it needs a small amount invested at the beginning. Furthermore, a distributed system using solar heat is available in islands or diverse small areas.

However, the conventional desalination technique using solar heat has drawbacks in that, a quantity of fresh water being produced is irregular due to disuniform solar radiation intensity and, when the solar radiation intensity is low, a yield is greatly reduced by lack of the quantity of heat. Therefore, the desalination system using solar heat needs the structures in that the solar collector is capable of absorbing a great quantity of energy per unit hour and the evaporator is capable of emitting a great quantity of energy, based on certain standards.

### SUMMARY OF THE INVENTION

To solve the above problems of the conventional art, it is therefore an object of the present invention to provide an evaporative desalination apparatus of sea water, using a phase change medium, in which, instead of water used in the prior art, a phase change medium is supplied as a heat source medium for supplying heat to an evaporator, thereby increasing a quantity of fresh water.

Water used in the prior art uses only the quantity of heat corresponding to a temperature difference, i.e., sensible heat. However, since the phase change medium provides the latent heat from a gas state and a liquid state, it provides sea water with a great quantity of energy, based on the heat transfer area of the same evaporator.

The above and other objects and advantages of the present invention will become more apparent by describing in detail exemplary embodiments thereof. Further, the objects and advantages of the present invention may be realized by the elements set forth in the claims and combinations thereof.

In accordance with an exemplary embodiment of the present invention, there is provided an evaporative desalination apparatus of sea water, using a phase change medium, comprising: a flow line through which the phase change medium flows; a thermal storage tank including a heat transfer pipe connected to the flow line; and a fresh water unit including an evaporation pipe connected to the flow line, to produce fresh water by phase-changing the phase change medium from a high temperature gas state to a liquid state and evaporating sea water inside by latent heat provided by the phase change medium during the phase change.

Furthermore, the thermal storage tank stores high temperature water heated by a heat source, to gasify the phase change medium in the liquid state through heat exchange with the high temperature water.

Furthermore, the thermal storage tank uses solar heat as the heat source, using a solar collector.

Furthermore, the fresh water unit comprises: an evaporator including the evaporation pipe installed in a storage tank storing sea water, so that the sea water is heated by the heat of the phase change medium; a condenser condensing steam generated by the evaporator, to produce fresh water; and a fresh water storage unit storing the fresh water.

Furthermore, the phase change medium heats the sea water by the heat emitted from its high temperature gas state and the latent heat emitted during it is phase-changed from the gas state to the liquid state by the heat exchange with the sea water.

Furthermore, the fresh water unit comprises: an ejector for discharging the sea water used as cooling water in the condenser and a portion of the steam generated from the sea water (but not condensed) and cooled outside the storage tank of the evaporator, and creating a vacuum in the fresh water unit.

Furthermore, the fresh water comprises: a separator between the evaporator and the condenser, for preventing a waterdrop of the steam from being drawn into the ejector when the ejector is operated to create a vacuum in the fresh water unit.

Furthermore, the condenser supplies a portion of the sea water used as the cooling water to condense the steam to the storage tank of the evaporator.

Furthermore, the flow line comprises: a liquid tank storing the phase change medium being liquefied after evaporating the sea water inside the fresh water unit; and a circulation pump circulating the phase change medium.

Furthermore, the phase change medium uses any one of R123 (dichlorotrifluoroethane), acetone, ethanol and methanol.

Furthermore, the evaporation pipe is formed in any one of a round tube, a plate and a combination of the round tube and plate.

### BRIEF DESCRIPTION OF THE DRAWINGS

The above and other features and advantages of the present invention will become more apparent by describing in detail exemplary embodiments thereof with reference to the attached drawings in which:

FIG. 1 is a system diagram illustrating a conventional single stage evaporative desalination apparatus using warm water by solar heat collection; and

FIG. 2 is a system diagram illustrating a desalination apparatus using solar heat and a phase change medium according to an exemplary embodiment of the present invention.

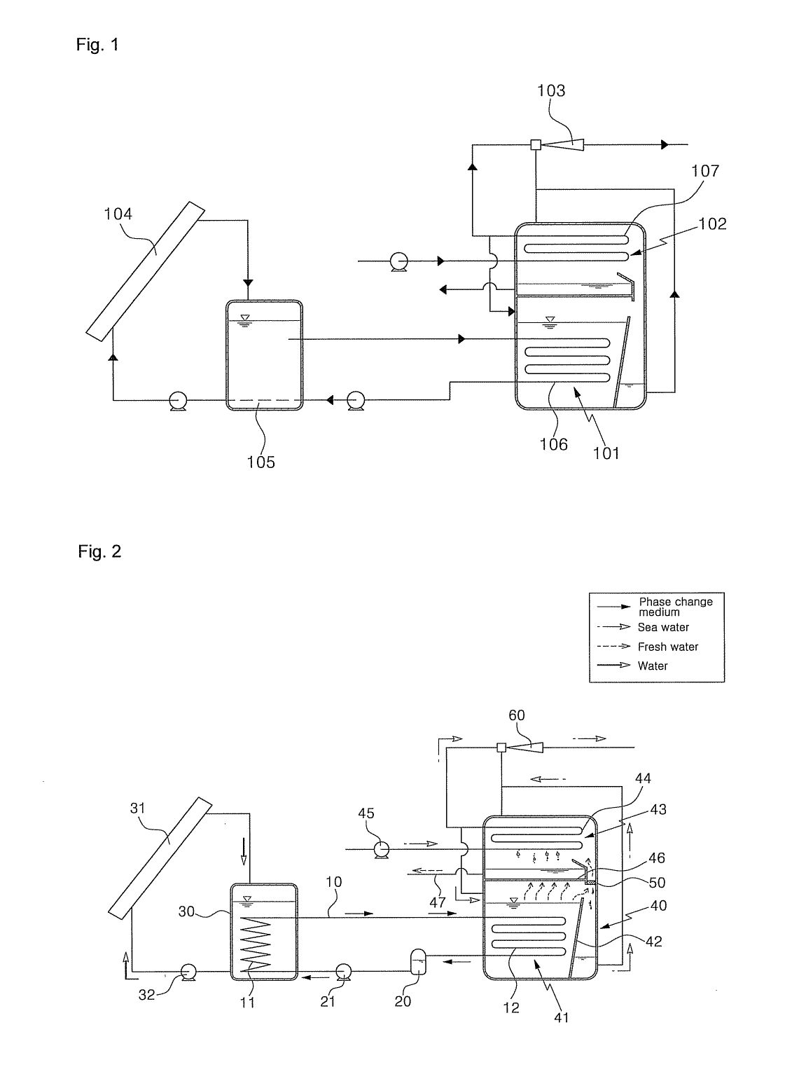

### BRIEF DESCRIPTION OF REFERENCE NUMBERS OF MAJOR ELEMENTS

10: flow line 11: heat transfer pipe
12: evaporation pipe 20: liquid tank
21: circulation pump 30: thermal storage tank
31: solar collector 40: fresh water unit
41: evaporator 42: storage tank
43: condenser 44: condensation pipe
45: pump 46: fresh water storage unit
47: discharge unit 50: separator
60: ejector

### DETAILED DESCRIPTION OF THE INVENTION

Before exemplary embodiments of the present invention are described in detail, it will be understood that, detailed constitution and arrangements of elements described in the detailed description or illustrated in the drawings should not be construed as limiting the application of the invention. The invention may be embodied in many alternate forms and performed in various methods. The terms or words to describe the direction of an apparatus or element (for example, “front”, “back”, “up”, “down”, “top”, “bottom”, “left”, “right” and “lateral”, among others) are used to simplify the description of the invention. It will be, therefore, understood that these terms do not mean that the relevant apparatus or element shall be only in the specific direction.

The present invention to achieve the aforementioned object(s) has the following characteristics:

The present invention will now be described more fully hereinafter with reference to the accompanying drawings, in which preferred embodiments of the invention are shown. It will be understood that words or terms used in the specification and claims shall not be interpreted as the meaning defined in commonly used dictionaries. It will be further understood that the words or terms should be interpreted as having a meaning that is consistent with their meaning in the context of the relevant art and the technical idea of the invention, based on the principle that an inventor may properly define the meaning of the words or terms to best explain the invention.

Accordingly, while example embodiments of the present invention are capable of various modifications and alternative forms, embodiments of the present invention are shown by way of example in the drawings and will herein be described in detail. It should be understood, however, that there is no intent to limit example embodiments of the invention to the particular forms disclosed, but on the contrary, example embodiments of the invention are to cover all modifications, equivalents, and alternatives falling within the scope of the invention.

In an evaporative desalination apparatus of sea water according to the present invention, which obtains fresh water by evaporating sea water by using high temperature water heated through the heat source such as solar heat or engine heat of a ship, a phase change medium, instead of warm water, is supplied to an evaporator 41. According to the technology of the present invention, a great quantity of fresh water per unit hour is produced by using latent heat when phase is changed from a gas state to a liquid state, and a great quantity of heat is absorbed and provided by a thermal storage tank 30 by using the latent heat by which a liquid is gasified.

Below, a method and structure of a desalination apparatus using solar heat according to a preferred exemplary embodiment of the present invention will be described with reference to the attached drawings.

FIG. 2 is a system diagram of a desalination apparatus of sea water, using latent heat provided by the phase change medium during a phase change according to the present invention.

An evaporation system in the desalination apparatus comprises: a flow line 10, a thermal storage tank 30 and a fresh water unit 40.

One end of the flow line 10 is connected to a heat transfer pipe 11 and the other end of the flow line 10 is connected to an evaporation pipe 12. A phase change medium flows through the inside of the flow line 10 so as to move and circulate through the heat transfer pipe 11 and the evaporation pipe 12. In the flow line 10, a liquid tank 20 is provided to store the phase change medium and supply the phase change medium to the flow line 10 and a circulation pump 21 is also provided to circulate the phase change medium.

The thermal storage tank 30 stores a heat source by using a solar collector 31. High temperature water heated by the stored heat source is stored in the thermal storage tank 30. Further, the heat transfer pipe 11 connected to the one end of the flow line 10 is installed to be in the high temperature water inside the thermal storage tank 30. The phase change medium flowing through the heat transfer pipe 11 heat-exchanges with the high temperature water within the thermal storage tank 30 and absorbs the heat of the high temperature water by the heat exchange, to be gasified through a phase change from a liquid state to a gas state.

The thermal storage tank 30 absorbs the latent heat of the phase change medium generated upon the phase change, and to be used for gasification of the phase change medium.

The evaporation pipe 12 of the flow line 10 is installed to be positioned in the fresh water unit 40. The fresh water unit 40 comprises the evaporator 41, a condenser 43 and a fresh water storage unit 46. The evaporator 41 is installed such that the evaporation pipe 12 is sunk in the storage tank 42 where sea water is stored.

That is, when the phase change medium which is phase-changed from the liquid state to the high temperature gas state through the thermal storage tank 30 flows through the evaporation pipe 12, it heat-exchanges with the sea water within the storage tank 42 where the evaporation pipe 12 is positioned, so that the sea water is heated to generate steam. Then, the phase change medium losing heat is continuously and repeatedly collected in the liquid tank 20.

In other words, the phase change medium in the gas state flows into the evaporator 41. However, the phase change medium loses heat during heating the sea water and is phase-changed to the liquid state. The latent heat generated from the phase change medium upon the phase change is used to heat the sea water.

The sea water heated in the evaporator 41 becomes steam, which is formed above the evaporator 41 and is moved to the condenser 43 including the condensation pipe 44, to be condensed. (In the condenser 43, a pump 45 is used so that cooling water flows inside. Sea water is used as the cooling water. A portion of the sea water after condensing the steam is again supplied to the storage tank 42 of the evaporator 41.) Subsequently, the condensed steam, i.e., fresh water, is stored in the fresh water storage unit 46 installed between the condenser 43 and the evaporator 41 and is removed through a discharge unit 47.

An ejector 60 draws the sea water used in the condenser 43 and a portion of the steam which is generated from the sea water in the evaporator 41 but not moved to the condenser 43 and which is cooled outside the storage unit 42 of the evaporator 41, to be discharged outside. (Since a general ejector ejects pressure, the air inside the fresh water unit 40 is drawn through negative pressure generated inside the ejector and is discharged outside.)

Further, the ejector 60 creates a vacuum in the fresh water unit 40 comprising the evaporator 41 and the condenser 43, to expedite the evaporation of the sea water inside the evaporator 41. When a vacuum is created in the fresh water unit 40 by drawing the air inside the fresh water unit 40, a waterdrop of the sea water stored in the evaporator 41 is also drawn into the ejector 60. Then, the waterdrop may cause corrosion, to shorten a life of the whole equipment. To prevent this problem, a separator 50 is installed between the condenser 43 and the evaporator 41.

Referring to FIG. 2, the fresh water storage unit 46 storing the fresh water is positioned between the condenser 43 and the evaporator 41. The steam generated in the evaporator 41 moves to the condenser 43 through a space formed at one side of the fresh water storage unit 46. That is, it is obvious that the separator 50 is installed at a position where the steam flows into the condenser 43 from the evaporator 41. The separator 40 passes the steam but does not allow the waterdrop to pass.

Examples of a typical phase change medium circulating through the system include R123 (dichlorotrifluoroethane), acetone, ethanol and methanol, among the others. Among these, the boiling point of R123, a newly developed firefighting material instead of R11, is 27.85° C. and the latent heat thereof is 171 kJ/kg (40.9 kcal/kg).

The system which produces one ton of fresh water per day by using R123 will be described below:
1) System using R123: Latent heat upon a phase change is used.
Energy required for an evaporator to produce one ton of fresh water per day: (1,000 kg/D×539 kcal/kg)÷ (24 h×60 min)=374 kcal/min
Mass circulation of a refrigerant to provide evaporation energy: 374 kcal/min÷40.9 kcal/kg=9.15 kg/min
   liquid circulation: 9.15 kg/min×(1/1.458 L/kg)=6.28 L/min
Quantity of heat absorption (when R123 is changed from a liquid state to a gas state) by a thermal storage tank 30: 374 kcal/min
   Gas circulation: 9.15 kg/min×(1/0.00647 L/kg)=1,414 L/min
   Gas circulation rate inside an evaporation pipe 12:
   1,414 L/min/60/cross sectional area of a pipe (0.45 cm×0.45 cm×3.14×12 items)=3.1 m/s

Considering that a design rate of a refrigerant steam at an inlet of a condensation pipe in a general refrigerator is 10˜18 m/s, it is analyzed that the flow rate of the steam in this system is very good for a condensation heat exchange.
2) Conventional system using warm water: Only a temperature difference of warm water is used.
Energy theoretically required for an evaporator to produce one ton of fresh water per day: 374 kcal/min
Use of a temperature difference of circulating warm water inside an evaporation pipe 12: 15° C.(60° C.→45° C.)
Water circulation required:
Q=m Cp dT
374 kcal/min=m (1 kcal/kg° C.) (15° C.)
m=25 kg/min=25 L/min

That is, whereas the liquid circulation in the conventional system using circulated water is 25 liters per minute, the liquid circulation in the system using a phase change medium is 6.28 liters.

The shaft power required in a general pump is directly proportional to the number of times of rotation, and the fluid circulation is proportional to the number of times of rotation. Therefore, the system according to the present invention has the effect of saving energy since the fluid flow is only 25% and the power of the circulation pump 21 for circulating the fluid is reduced to ¼, compared to the conventional system using water.

Further, since the flow of two phases (liquid/gas) is formed in the evaporation pipe 12 of the system according to the present invention, the system is a very excellent heat transfer system in which the heat transfer coefficient increases by 5˜10 times, compared to a single phase, water. Since it greatly reduces the heat transfer area, it is possible to manufacture an effective desalination system enabling a compact evaporator 41. In the same manner, the present invention is applied to a multi-effect evaporation system using a number of evaporators 41 to enhance effects and increase a yield of fresh water.

The two-phase flow (changed from a liquid to a gas) is formed in the heat transfer of the thermal storage tank 30. Therefore, since the quantity of heat transfer per hour is greatly increased, the length of the heat transfer pipe 11 in the thermal storage tank 30 is reduced.

The structure of the evaporation pipe 12 may be formed in any one of a round tube, a plate and a combination of the round tube and plate. It is understood that this includes the structures in various modified shapes to which the principle using the phase change medium is used in the evaporator 41 in the desalination system within the scope of the technical ideas defined in the following claims.

The present may be applied to not only the evaporative desalination systems using solar heat, engine heat and the like but also the evaporative desalination systems using newly recycled energy such as the heat of the earth and the like and the large or small evaporative desalination systems. Specifically, the present invention is an advance technology more effective to the small-sized desalination systems for islands or small areas.

As described above, in the evaporative desalination apparatus of sea water to produce fresh water by evaporating sea water by using high temperature water by solar heat or engine heat of a ship, the phase change medium, instead of warm water, is supplied to the evaporator inside the desalination apparatus. Accordingly, a great quantity of fresh water per unit hour is produced by using the latent heat provided during the phase change from the gas state to the liquid state. Furthermore, the thermal storage tank absorbs and provides the great quantity of heat by using the latent heat when the liquid is gasified.

Further, according to the present invention, the power required for circulating the heat source medium is decreased to ¼, compared to the conventional system using warm water, thereby saving energy.

Further, since the heat transfer phenomenon of two phase fluids is formed inside the evaporator and the thermal storage tank, a heat transfer coefficient is greatly increased, to significantly reduce the heat transfer area. Specifically, in the desalination apparatus using solar heat, the amount of fresh water which is produced per unit hour is greatly increased, based on the same area.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An evaporative desalination apparatus of sea water, using a phase change medium, comprising:
a flow line (10) through which the phase change medium flows;
a thermal storage tank (30) in which a heat transfer pipe (11) connected to the flow line (10) is installed; and
a fresh water unit (40) in which an evaporation pipe (12) connected to the flow line (10) is installed, to produce fresh water by phase-changing the phase change medium in a high temperature gas state to a liquid state and by evaporating the sea water inside by using latent heat provided by the phase change medium during the phase change.

2. The evaporative desalination apparatus of claim 1, wherein the thermal storage tank (30) stores high temperature water heated by a heat source, to gasify the phase change medium in the liquid state by a heat exchange with the high temperature water.

3. The evaporative desalination apparatus of claim 1, wherein the thermal storage tank (30) uses solar heat as the heat source, using a solar collector (31).

4. The evaporative desalination apparatus of claim 1, wherein the fresh water unit (40) comprise:
an evaporator (41) including the evaporation pipe (12) installed in a storage tank (42) storing the sea water, to heat the sea water through the heat of the phase change medium;
a condenser (43) condensing steam generated by the evaporator (41), to produce fresh water; and
a fresh water storage unit (46) storing the fresh water.

5. The evaporative desalination apparatus of claim 4, wherein the phase change medium heats the sea water, by using the heat emitted when it is in the high temperature gas state and the latent heat emitted when it is phase-changed from the gas state to the liquid state by the heat exchange with the sea water.

6. The evaporative desalination apparatus of claim 4, wherein the fresh water unit (40) further comprises:
an ejector (60) discharging the sea water used as cooling water in the condenser (43) and a portion of the steam generated from the sea water in the evaporator (41) but not moved to the condenser (43) and cooled outside the storage tank (42) of the evaporator (41), and creating a vacuum in the fresh water unit (40).

7. The evaporative desalination apparatus of claim 6, wherein the fresh water unit (40) comprises:
a separator (50) between the evaporator (41) and the condenser (43), to prevent a waterdrop within the evaporator (41) from being drawn into the ejector (60) when the ejector (60) is operated to create a vacuum in the fresh water unit (40).

8. The evaporative desalination apparatus of claim 4, wherein the condenser (43) supplies a portion of the sea water used as the cooling water to condense the steam to the storage tank (42) of the evaporator (41).

9. The evaporative desalination apparatus of claim 1, wherein the flow line (10) further comprises:
a liquid tank (20) for evaporating the sea water within the fresh water unit (40) and storing the liquefied phase change medium; and
a circulation pump (21) for circulating the phase change medium.

10. The evaporative desalination apparatus of claim 1, wherein the phase change medium uses any one of R123 (dichlorotrifluoroethane), acetone, ethanol and methanol.

11. The evaporative desalination apparatus of claim 1, wherein the evaporation pipe (12) is formed in any one of a round tube, a plate or a combination of the round tube and plate.
